(19) United States
(12) Patent Application Publication
(10) Pub. No.: US 2018/0016432 A1
(43) Pub. Date: Jan. 18, 2018

(54) ACRYLONITRILE BUTADIENE STYRENE (ABS) POLYMERS AND LINERS

(71) Applicants: Shuwen PENG, Shanghai (CN); Hongyan XU, Shanghai (CN); Rongwei PAN, Shanghai (CN); Huizhong WANG, Shanghai (CN); Min ZHA, Shanghai (CN); HONEYWELL INTERNATIONAL INC., MORRIS PLAINS, NJ (US)

(72) Inventors: Shuwen PENG, Shanghai (CN); Hongyan XU, Shanghai (CN); Rongwei PAN, Shanghai (CN); Huizhong WANG, Shanghai (CN); Min ZHA, Shanghai (CN)

(21) Appl. No.: 15/548,849

(22) PCT Filed: Feb. 6, 2015
(86) PCT No.: PCT/CN2015/072426

§ 371 Date: Aug. 4, 2017

(51) Int. Cl. C08L 55/02; C08L 25/12; F25D 23/08

(52) U.S. Cl. CPC C08L 55/02; F25D 23/08; C08L 25/12; C08L 2205/03

(57) ABSTRACT

The present invention relates to polymeric materials and liners for a container adapted to hold a food and/or beverage container in a cooled condition. In certain aspects, it includes (a) at least one co-polymeric chain which imparts plastic characteristics to said liner material; and (b) one or more rubber moieties grafted to and/or dispersed in said at least one first co-polymeric chain, wherein said one or more rubber moieties comprises at least about 30% by weight of said liner. In other aspects, it includes (a) at least one co-polymeric chain which imparts plastic characteristics to said liner material; and (b) one or more rubber moieties grafted to and/or dispersed in said at least one co-polymeric chain, wherein said one or more rubber moieties are present in the liner in an amount effective to ensure that said liner exhibits no stress cracking after one thermal test cycle.

### RELATED APPLICATIONS

This application is a National Stage application claiming the priority to PCT Application No. PCT/CN15/072426, filed Feb. 6, 2015, which is incorporated herein by reference.

### FIELD OF THE INVENTION

The present invention relates, generally, to improved polymeric compositions and liners for use in refrigeration systems, and more particularly to liners for use in conjunction with foam insulation produced using HFOs, HCFOs, or blends thereof, as the blowing agent.

### BACKGROUND OF THE INVENTION

Devices such as refrigerators, cold boxes, freezers and the like include a cooling cabinet that usually contains an outer cabinet (usually metal), an inner plastic liner and an insulating foam core, typically polyurethane foam, in the space between the metal cabinet and the liner. The foam insulation contains cells that are filed with the blowing agent that was used to form the polyurethane foam. In the past, completely halogenated methane, such as fluorotrichloromethane (CFC-11), was most commonly used as the blowing agent. More recently, more environmentally acceptable substitutes, such as HCFCs, including 2-fluoro-2,2-dichloroethane (HCFC-141b) and 2,2-dichloro-1, 1,1-trifluoroethane (HCFC-123), and HFCs, including HFC-245fa, have been used. More recently, the use of trans-1-chloro-3,3,3-trifluoropropene (HCFO-1233zd(E)) has also been proposed for use as a blowing agent in such applications.

In general, it is not uncommon for some portion of the blowing agent used to form polyurethane foams to escape over time from the cells that contain them. As a result, the design of such devices must take into account the interrelationship that the blowing agent will have with the liner of the refrigerator, freezer and the like. For this reason, many of the blowing agents which have been used to form polyurethane foams (such as Freon (CFC-11) and Freon substitutes, such as 2-fluoro-2,2 dichloroethane and 2,2-dichloro-1,1,1-trifluoroethane (HCFC 141b and HCFC 123, respectively), have been studied for their impact on liners and have been found to potentially cause environmental stress cracking (ESC) such as liner blistering, catastrophic cracks, tiny cracks (crazing) and loss of impact properties (embrittlement), as well as stress whitening and/or dissolution. More recently used blowing agents such as HCFC 141b, HCFC 123 and HCFO-1233zd appear to have also exhibited a relatively high level of aggressiveness toward many liner materials. The liner material can be formed from a large variety of materials. (See for example, U.S. Pat. No. 6,589,646, which is incorporated herein by reference). One of the most important and commonly used materials to form the liner is acrylonitrile-butadiene-styrene (ABS) resin.

U.S. Pat. No. 6,528,591, which is also incorporated herein by reference, discloses processes for preparing extrusion grade ABS polymer suitable for making refrigerators liners. According to this patent, ABS polymer can be in the form a grafted diene rubber wherein grafted phase comprises the (co)polymerization product of a monoalkenyl aromatic monomer (exemplified by and sometimes referred to below as “styrene”) and an ethylenically unsaturated nitrile monomer (exemplified by and sometimes referred to below as “acrylonitrile”). The patent describes a process that involves the use of a series of reactors to process monomer mixture comprising principally monoalkenylaromatic monomer (eg: styrene) and an ethylenically unsaturated nitrile monomer (acrylonitrile) that will polymerize readily to form copolymers of a matrix phase in the presence of a dispersed rubber (polybutadiene) phase. According to the patent, the copolymer in the partially polymerized mixture is formed as a free, or matrix phase polymer and as a polymer grafted on the diene rubber particles. The patent indicates that the matrix phase and grafted copolymers will have about the same composition for a given formulation, and that the rubber content of the solution fed to the first reactor a positive amount up to 15%, preferably up to 12%, by weight.

Another example of such ABS resins is disclosed in U.S. Pat. No. 5,324,589, which is incorporated herein by reference. Other materials of construction include glass-clear polystyrene (GPPS), impact-modified polystyrene (HIPS), styrene 6, copolymers, such as styrene-butadiene block copolymers, ASA, SAN, polyolefins, such as polyethylene or polypropylene, acrylates and methacrylates, such as PMMA, polycarbonates (PCs), polyvinyl chloride (PVC), polyethylene terephthalate (PET) and mixtures of these.

Applicants have particularly come to recognize a need to provide solutions for the problem of environmental stress cracking that can occur in such applications when the liner is comprised of ABS. More specifically, applicants have come to appreciate that liner cracking has an increased tendency to occur when HCFO-1233zd(E) is used as blowing agent in the refrigerator foam insulation. Most of the cracking starts at high stress areas (corner, front flange, shelf support) and runs from one high stress area to another. Accordingly, methods of addressing such cracking and impacting liner compatability with HCFO-1233zd are desirable.

U.S. Pat. No. 5,340,208 provides one possible solution. It describes the use of a plastic (e.g. ABS or HIPS) liner in conjunction with a polyurethane-based insulating foam. The liner, in particular, includes a composite of a barrier layer and a core layer. The barrier layer is said to be designed to be chemically inert to halogenated hydrocarbons, such as the blowing agents used in the polyurethane foam. It is formed from a polymer or copolymer of ethylene or propylene containing 0 to 40% by weight of a block copolymer rubber. The added barrier layer increases cost to produce the liner. Thus, more cost efficient alternatives are more desirable.

Much like the above, U.S. Pat. No. 5,834,426 relates to the use of a barrier layer for the liner to prevent interaction with blowing agents from the polyurethane foam. Its barrier layer is a composite of a maleated polyethylene compound and rubber. Again, the added barrier layer increases the cost to produce the liner. More cost efficient alternatives are desirable.

U.S. Pat. No. 6,613,837, as a solution to the problems outlined above, provides a rubber modified monovinyl aromatic compound. U.S. Pat. Nos. 6,706,814 and 6,545,090 describes, as a solution, a rubber modified monovinylidene aromatic polymer that includes a monovinylidene aromatic polymer matrix and rubber particles dispersed in that matrix. U.S. Pat. Nos. 6,008,294 and 6,027,800 both describe varying forms of thermoplastic material that includes a rubber modified vinyl-based polymer, an olefin polymer, and a styrene-isoprene-styrene compatibilizer.

### SUMMARY

One aspect of the present invention involves liners formed from polymeric materials which comprise: (a) at least one plastic co-polymer and/or portion of a co-polymer that imparts plastic properties to the material; and (b) a rubber moiety that is covalently bonded to and/or substantially uniformly distributed, and preferably in certain embodiments uniformly dispersed in, said at least one co-polymer, wherein the total rubber content in the polymeric material is not less than about 30% by weight and preferable in certain embodiments in amount from about 30% by weight to about 70% by weight. Applicants have surprisingly found that exceptional performance properties can be achieved according to the invention in terms of the resistance of such material to ESCR and that this performance is generally not achieved when the rubber component is below about 30% by weight.

As used herein, the term “plastic co-polymer” is intended to mean any co-polymeric material that is formed from two or more monomeric material and which has plastic properties at about room temperature. It will be appreciated therefore that the term “co-polymer” encompasses not only polymers formed from two monomers, but also polymers which are formed from more than two monomers, such as for example three monomers, which are commonly known as ter-polymers.

In certain preferred embodiments the plastic co-polymer of the present invention is selected from polymers having portions formed from acrylonitrile and styrene monomers. In certain embodiments, the plastic co-polymer comprises, and in certain preferred embodiments consists essentially of, and in even further preferred embodiments consists of, portions formed by the co-polymerization of acrylonitrile and styrene monomers, such as SAN polymers. As mentioned above, and is preferred in certain embodiments, the polymeric materials of the present invention include plastic co-polymers having rubber moieties grafted thereto. In certain highly preferred embodiments the polymeric material of the present invention comprises a first plastic co-polymer which has no substantial portion of rubber moieties grafted thereto, such as SAN co-polymer and a second plastic co-polymer having rubber moieties grafted thereto and/or uniformly distributed therethrough, such as ABS co-polymers, wherein the amount of rubber moieties in the material is at least 30% by weight based on the total weight of the polymeric material.

In certain embodiments, the present invention relates to a liner for a container adapted to hold a food and/or beverage in a cooled condition. The liner is preferably formed from a polymeric material of the present invention, and preferably includes at plastic co-polymer formed from acrylonitrile and styrene monomers and has sufficient rubber moieties grafted thereto to produce a polymeric material having a rubber content of not less than about 30 wt. %, based on the total weight of the polymeric material. The rubber moieties according certain preferred embodiments can be selected from and/or produced from monomers selected from the group consisting of butadiene, styrene-butadiene, butadiene-acrylonitrile copolymers, isoprene, ethylene/propylene rubbers, ethylene/propylene/diene rubbers, nonconjugated diene, crosslinked alkylacrylate rubber, and combinations any two or more thereof. Plastic co-polymers of the present invention which have such rubber moieties grafted thereto are sometimes referred to herein as “rubber-grafted plastic co-polymers” for the purposes of convenience. One example of such “rubber-grafted plastic co-polymers” are materials known as ABS polymers or resins, including those which have the core-shell arrangement.

In certain preferred embodiments, the polymeric material of the present invention, and the liners formed therefrom, comprise: (a) at least one rubber-grafted plastic co-polymers, such as ABS resin and ASA resin; and (b) at least one plastic co-polymer which does not have any substantial amount of rubber moieties grafter thereto, wherein the amount of rubber contained in rubber-grafted plastic co-polymers and the relative amount of components (a) and (b) provide a material having at least 30% by weight of rubber moieties present. In certain non-limiting embodiments, the second plastic co-polymer (b) having no substantial rubber content acts as carrier or dispersant for the rubber-grafted plastic co-polymers. In certain preferred embodiments the second plastic co-polymer (b) comprises, more preferable consists essentially of, and in certain embodiments consists of, a styrene acrylonitrile (SAN) co-polymer or resin.

In certain preferred embodiments, the polymeric material of the present invention, and the liners formed therefrom comprise: (a) at least first co-polymeric chains which impart plastic characteristics to said material, wherein said first co-polymeric chains have (i) no rubber moieties grafted thereto; or (ii) rubber moieties grafted thereto; and/or rubber moieties in fine particulate form distributed substantially uniformly therethrough, wherein the amount of said rubber moieties grafted to and distributed in said first co-polymeric chains together is not greater than about 24% by weight based on the weight of said first co-polymeric chains and said rubber moieties grafted to and distributed in said first co-polymeric chains; or a combination of (i) and (ii); and (b) second co-polymeric chains having rubber moieties grafted thereto, wherein the amount of said rubber moieties grafted to said second co-polymeric chains is not less than about 40% by weight based on the weight of said second co-polymeric chains and said rubber moieties grafted to said second co-polymeric chains, wherein the total rubber moieties in said polymeric material comprises from about 30% by weight to about 50% by weight of said polymeric material.

In certain embodiments of the present invention the polymeric material and the liners formed therefrom further include a thermoplastic plastomer/elastomer. The thermoplastic plastomer/elastomer may include a polymer or terpolymer of non-polar monomer and other polar monomers. The non-polar monomer may be selected from the group consisting of ethylene, propylene, butylene, butadiene, pentadiene, hexylene, octylene, styrene, and combinations thereof. The polar monomer may be selected from the group consisting of vinyl acetate, alkyl acrylate, glycidyl methylacrylate, maleic anhydride, and combinations thereof. In certain embodiments, the thermoplastic plastomer/elastomer comprises a terpolymer of ethylene, alkyl acrylate, and glycidyl methacrylate. In further embodiments, the thermoplastic plastomer/elastomer comprises an ethylene-vinyl acetate (EVA) copolymer. In even further embodiments, the thermoplastic plastomer/elastomer comprises a terpolymer of methyl methacrylate, butadiene, styrene (MBS).

The present invention also relates to method for producing a liner for applications such as refrigerators and the like, including preferably the step of extruding any one or combination of the polymeric materials described herein into a shape adaptable for use in such applications.

The present invention also relates to a device for containing item(s) or fluid(s) at a temperature below ambient temperature comprising: a container or compartment having an interior space for holding food and/or beverage in a cooled condition, said container comprising a liner comprising (a) any one or combination of the compositions above, or otherwise herein, having a rubber content of greater than about 30 wt. %, based on the total weight of the polymeric material in the liner; and (b) thermal insulation comprising a polymeric material having closed cells therein wherein said cells are formed from and/or contain a halogenated hydrocarbon blowing agent, and even more preferably a hydrohaloolefin blowing agent. In certain embodiments, the blowing agent comprises transHFCO-1233zd.

Additional embodiments and advantages to the present invention will be readily apparent to the skilled artisan on the basis of, at least, the disclosure and examples provided below.

### DETAILED DESCRIPTION

In certain preferred aspects, the present invention relates to a formulated ABS polymeric material with high rubber content and to methods of manufacturing and using such material. As demonstrated herein, such material can be formed into and used as a refrigerator liner having desirable but difficult-to-obtain properties, including improved environmental stress cracking resistance (ESCR) and/or good ESCR when in the presence of hydrohalcarbon materials used as blowing or foaming agents, such as HCFO-1233zd(E).

As used herein, the term “ABS polymer” means a polymeric material that is: (i) in the form of a grafted diene rubber wherein grafted phase comprises the (co)polymerization product of a monoalkenyl aromatic monomer (exemplified by and sometimes referred to below as “styrene”) and an ethylenically unsaturated nitrile monomer (exemplified by and sometimes referred to below as “acrylonitrile”).

As used herein, the term “SAN polymer” refers to co-polymers formed from alkenylaromatic monomers (such as styrene) and ethylenically unsaturated nitrile monomer (such as acrylonitrile) and generally are in the form a random, amorphous structure. In certain non-limiting embodiments, the SAN copolymer of the present invention contains from about 70 wt. % to about 80 wt. % styrene and from about 20 wt. % to about 30 wt. % acrylonitrile. Such a combination provides higher strength, rigidity, and chemical resistance than polystyrene, alone.

As used herein, the term “high rubber ABS polymer” means an ABS polymer in which total rubber moieties comprise at least about 30% by weight based on the total weight of the ABS polymer.

In certain non-limiting embodiments, the high rubber ABS polymer of the present invention can be used alone, or in certain preferred aspects it is compounded with a second plastic co-polymer, such as polystyrene-co-acrylonitile (SAN) and/or an ABS polymer that is not a high rubber content ABS polymer.

It is contemplated that in certain, but not necessarily preferred embodiments, the polymeric material will comprise a first plastic co-polymer with no rubber content grafted thereto and rubber particle dispersed in said plastic co-polymer. It is contemplated that such embodiments may require an agent or component to compatiblize the rubber particles with the first plastic-copolymer to ensure that the rubber particles can maintained in the plastic phase and impart the advantageous properties disclosed herein.

In certain non-limiting aspects, the first plastic co-polymer, such as ABS polymer or resin, may be grafted or compounded with a thermoplastic plastomer/elastomer, as described more fully hereinafter.

ABS Resin

It is contemplated that those skilled in the art will be able, in view of the disclosure contained herein, to select and/or prepare the appropriate ABS resin, including the high rubber ABS resin, for use with each particular application. In certain aspects, it is generally preferred, that the ABS resin is a grade that provides deep draw capability in thermoforming operations. Furthermore, it is preferred that the ABS resin layer have a high gloss and a high rubber content.

As described above, the high rubber ABS polymer of this invention comprises three building blocks, namely an unsaturated nitrile monomer, a diene rubber, and a vinyl aromatic monomer, (for example, acrylonitrile, polybutadiene rubber, and styrene), which can vary widely with respect to the percentage used. The proportion of these components can be tailored to desired needs such as chemical resistance, heat stability, impact resistance, toughness, rigidity, and processing needs. The relative proportion of these components will vary with respect to the desired end use according to the needs of those skilled in the art.

In certain preferred embodiments, the high rubber ABS of the present invention comprises polybutadiene rubber in an amount that is not less than about 30 wt. %, based on the total content of the ABS. In even further embodiments, the polybutadiene rubber is provided in an amount from about 30 wt. % to about 60 wt. %, based on the total content of the ABS.

In the embodiments above, the rubber portion is derived, primarily, from the butadiene residue. The present invention, however, is not limited to such an aspect. Compositionally, the rubber portion of the resin may be comprised of polybutadiene, styrene-butadiene or butadiene-acrylonitrile copolymers, polyisoprene, EPM (ethylene/propylene rubbers), EPDM rubbers (ethylene/propylene/diene rubbers containing as diene, a nonconjugated diene such as hexadiene-(1,5) or norbomadiene in small quantities) and crosslinked alkylacrylate rubbers based on C1-C8 alkylacrylates, in particular ethyl, butyl and ethylhexylacrylate, and any combination of two or more of these.

The acrylonitrile component of the ABS resin may be provided in an amount from about 5 to about 35 wt. %, based on the total weight of the ABS components.

The styrene component of the ABS resin may be provided in an amount 10 to about 60 wt. %, based on the total weight of the ABS components.

As demonstrated below, ABS having proportions of rubber moieties according to preferred aspects of the present invention provides unexpected but desirable structural advantages to the articles formed therefrom, including liners, in particular resistance to cracking (e.g., ESC) in the presence of HCFO-1233zd(E), and/or low temperature impact resistance.

In preferred embodiments, the high rubber ABS of the present invention comprises styrene-acrylonitrile copolymer grafted with polybutadiene and/or having polybutadiene dispersed therein as discrete particles. The ABS resin may be prepared according to any of the methods well known in the art including emulsion, bulk, mass or suspension processes or a combination of these processes. Preferably, though not necessarily limiting to the invention, the ABS resin is made by emulsion polymerization in order to have a high gloss appearance.

The present polymeric material are preferably or compounded to ensure that the content of rubber moieties in the material is sufficient to substantially reduce and/or eliminate cracking of liners formed therefrom when such liners are exposed to hydrohalocarbons, and particularly hydrohaloolefins such as HCFO-1233zd(E). In certain embodiments, the total rubber content of the polymeric material is from about 30 wt. % to about 60 wt. %.

SAN copolymers, as used herein, refer to styrene and acrylonitrile monomers that are

In certain non-limiting embodiments, small amounts of SAN are grafted onto the HRG rubber particles to compatibilize the dispersed rubber phase and continuous SAN phase.

Thermoplastic Plastomer/Elastomer

In certain non-limiting aspects, the thermoplastic plastomer/elastomer can be a copolymer or terpolymer of non-polar monomer and other polar monomers. Non-limiting examples of a non-polar monomer can be ethylene, propylene, butylene, butadiene, pentadiene, hexylene, octylene, styrene, and the like. Non-limiting examples of a polar monomer can be vinyl acetate, alkyl acrylate, glycidyl methylacrylate, maleic anhydride, and the like or blends thereof.

In certain embodiments, the thermoplastic plastomer/elastomer is a terpolymer of ethylene, alkyl acrylate, and glycidyl methacrylate. In such embodiments, the ethylene component may be provided in an amount from about 5 wt. % to about 60 wt. % of the total weight of the terpolymer. The alkyl acrylate may be provided in an amount from about 10 wt. % to about 60 wt. % of the total weight of the terpolymer. The glycidyl methacrylate (GMA) component may be provided in an amount from about 1 wt. % to about 50 wt. % of the total weight of the terpolymer. Such terpolymers may be provided to the ABS polymeric composition in an amount of at least about 2.5 wt. %, based on the total weight of the ABS. In further embodiments, such terpolymers are provided in an amount of at least about 0.1 wt. %, or more preferably from about 0.5 wt. % to about 50 wt. %, based on the total weight of the ABS. Non-limiting examples of such terpolymers that may be used with the present invention include Elvaloy® PTW from Dupont and LOTADER® AX 8900 (25 wt % acrylate and 8 wt % GMA, MFI: 6 (190° C./2.16 kg)) from Arkema.

In further embodiments, the thermoplastic plastomer/elastomer is an ethylene-vinyl acetate (EVA) copolymer. In certain non-limiting embodiments, the polymer as a vinyl acetate content of from about 10 to about 50 wt % with an ethylene content of from about 50 wt % to about 90 wt. %. Such EVAs may be provided to the ABS polymeric composition in amounts of at least about 0.1 wt. %, or more preferably from about 0.05 wt. % to about 50 wt. %, based on the total weight of the ABS. Non-limiting examples of EVAs that may be used in conjunction with the present invention include EVM50, EVA33, EVA14.

In further embodiments, the thermoplastic plastomer/elastomer is a terpolymer of methyl methacrylate, butadiene, styrene (MBS). In such embodiments, the methyl methacrylate component may be provided in an amount from about 1 wt. % to about 60 wt. % of the total weight of the terpolymer. The butadiene may be provided in an amount from about 1 wt. % to about 90 wt. % of the total weight of the terpolymer. The styrene component may be provided in an amount from about 1 wt. % to about 60 wt. % of the total weight of the terpolymer. Such terpolymer may be provided in the ABS polymeric composition in an amount of at least about 0.01 wt. %, based on the total weight of the ABS. In further embodiments, such terpolymers are provided in the ABS polymeric composition in an amount of at least about 0.5 wt. %, or more preferably from about 0.5 wt. % to about 50 wt. %, based on the total weight of the ABS. Non-limiting examples of EVAS that may be used in conjunction with the present invention include K175 from Dow Chemical.

Liner Forming Methods

It is contemplated that methods and techniques known to those skilled in the art may be used to form the liners of the present invention from the polymeric materials disclosed herein. For example, the liner can be produced by injection molding but more preferably extrusion of the materials. It is contemplated that any method or technique, including combinations of two or more methods, may be used. To this end, all known techniques are contemplated and considered to be within the scope of the present invention.

Applications

The liners of the present invention may be used in a variety of applications. In preferred embodiments, the liners are included in relatively small refrigeration systems such as domestic refrigerators and freezers, vending machines, reach-in coolers, transport refrigeration units and the like, can provide such systems with highly advantageous energy performance while at the same time providing such systems that have extraordinarily low environmental impact and are durable and long-lasting.

One aspect of the present invention provides systems, devices and methods for containing item(s) or fluid(s) at a temperature either below or above the ambient temperature, preferably for an extended period of time (such as at least several hours or days). Such systems, devices, and methods include (a) a container or compartment for holding an item(s) or fluid(s) to be maintained in a cooled or heated condition relative to the ambient; (b) thermal insulation disposed with respect to said container or compartment so as to inhibit the flow of heat into and/or out of the compartment, said insulation comprising a polymeric material having closed cells therein wherein said cells are formed from and/or contain a blowing agent. In preferred embodiments, the blowing agent comprises a haloalkene according to Formula IA:

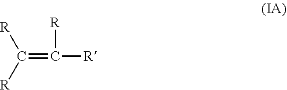

where each R is independently Cl, F, H, or CF₃, provided that the total number of carbon atoms is either 3 or 4,

R′ is (CR₂)ₙY,

Y is CF₃

and n is 0 or 1;

and (c) a heat transfer system for adding and/or removing heat from the compartment or container by use of a heat transfer fluid comprising a haloalkene Formula IB:

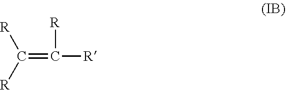

where each R is independently Cl, F or H

R′ is (CR₂)ₙY,

Y is CF₃

and n is 0 or 1.

As used herein the terms container and compartment are used in the broad sense and are not limited to containers that fully enclose or surround the items or fluid being contained. Thus, for example, containers that have relatively permanent openings, such as would be the case in reach-in coolers and refrigerators, are encompassed within the meaning of this term.

In certain preferred embodiments the compound of Formula IA comprises, and preferably comprises at least about 25% by weight, and more preferably comprises at least about 30% by weight, and even more preferably consists essentially of one or more compounds selected from 1,1,1,4,4,4-hexafluoro-2-butene (1336mzz), 1-chloro-3,3,3-trifluoropropene (1233zd), and 1,3,3,3-tetrafluoropropene (1234ze). In certain highly preferred aspects of such embodiments, the 1-chloro-3,3,3-trifluoropropene (1233zd) is trans-1-chloro-3,3,3-trifluoropropene (1233zd(E)), the 1,3,3,3-tetrafluoropropene (1234ze) is trans1,3,3,3-tetrafluoropropene (1234ze(E)), and the 1,1,1,4,4,4-hexafluoro-2-butene (1336mzz) is cis1,1,1,4,4,4-hexafluoro-2-butene (1336mzz (Z)).

In certain preferred embodiments, including particularly and preferably the embodiments in which the compound of Formula 1A comprises, and preferably comprises at least about 50% by weight, and more preferably comprises at least about 70% by weight, and even more preferably consists essentially of one or more compounds selected from 1,1,1,4,4,4-hexafluoro-2-butene (1336mzz), 1-chloro-3,3,3-trifluoropropene (1233zd), and 1,3,3,3-tetrafluoropropene (1234ze), and the compound of Formula IB comprises, and preferably comprises at least about 50% by weight, and more preferably comprises at least about 70% by weight, and even more preferably consists essentially of one or more compounds selected from 1-chloro-3,3,3-trifluoropropene (1233zd) (preferably trans-1233zd), 2,3,3,3-tetrafluoropropene (1234yf) and 1,3,3,3-tetrafluoropropene (1234ze) (preferably trans-1234ze). In certain of such embodiments, the 1-chloro-3,3,3-trifluoropropene (1233zd) is trans1-chloro-3,3,3-trifluoropropene (1233zd(E)), the 1,3,3,3-tetrafluoropropene (1234ze) is trans1,3,3,3-tetrafluoropropene (1234ze(E)), and the 1,1,1,4,4,4-hexafluoro-2-butene (1336) is cis1,1,1,4,4,4-hexafluoro-2-butene (1336(Z)).

In certain preferred embodiments, the compound of Formula 1A comprises, and preferably comprises at least about 50% by weight, and more preferably comprises at least about 70% by weight, and even more preferably consists essentially of one or more compounds selected from 1,1,1,4,4,4-hexafluoro-2-butene (1336mzz), and 1-chloro-3,3,3-trifluoropropene (1233zd), and the compound of Formula IB comprises, and preferably comprises at least about 50% by weight, and more preferably comprises at least about 70% by weight, and even more preferably consists essentially of one or more compounds selected from 2,3,3,3-tetrafluoropropene (1234yf) and 1,3,3,3-tetrafluoropropene (1234ze) (preferably trans-1234ze).

In certain preferred embodiments, the compound of Formula 1A comprises, and preferably comprises at least about 50% by weight, and more preferably comprises at least about 70% by weight, and even more preferably consists essentially of one or more compounds selected from 1,1,1,4,4,4-hexafluoro-2-butene (1336mzz) and 1-chloro-3,3,3-trifluoropropene (1233zd), and the compound of Formula IB comprises, and preferably comprises at least about 50% by weight, and more preferably comprises at least about 70% by weight, and even more preferably consists essentially of 1,3,3,3-tetrafluoropropene (1234ze), and even more preferably trans-1234ze.

In certain preferred embodiments, the compound of Formula 1A comprises, and preferably comprises at least about 50% by weight, and more preferably comprises at least about 70% by weight, and even more preferably consists essentially of 1,1,1,4,4,4-hexafluoro-2-butene (1336mzz) (preferably cis-1336mzz) and the compound of Formula IB comprises, and preferably comprises at least about 50% by weight, and more preferably comprises at least about 70% by weight, and even more preferably consists essentially of 1,3,3,3-tetrafluoropropene (1234ze), and even more preferably trans-1234ze.

In certain preferred embodiments, the compound of Formula 1A comprises, and preferably comprises at least about 50% by weight, and more preferably comprises at least about 70% by weight, and even more preferably consists essentially of one or more compounds selected from 1,1,1,4,4,4-hexafluoro-2-butene (1336mzz) (preferably cis-1336) and the compound of Formula IB comprises, and preferably comprises at least about 50% by weight, and more preferably comprises at least about 70% by weight, and even more preferably consists essentially of and 1-chloro-3,3,3-trifluoropropene (1233zd) (preferably trans-1233zd).

In certain preferred embodiments, the compound of Formula 1A comprises, and preferably comprises at least about 50% by weight, and more preferably comprises at least about 70% by weight, and even more preferably consists essentially of one or more compounds selected from 1-chloro-3,3,3-trifluoropropene (1233zd) (preferably trans-1233zd) and the compound of Formula IB comprises, and preferably comprises at least about 50% by weight, and more preferably comprises at least about 70% by weight, and even more preferably consists essentially of and 1,3,3,3-tetrafluoropropene (1234ze), and even more preferably trans-1234ze.

In certain preferred embodiments, the compound of Formula 1A comprises at least about 50% by weight, and more preferably comprises at least about 70% by weight, and even more preferably consists essentially of 1-chloro-3,3,3-trifluoropropene (1233zd) (preferably transHCFO-1233zd), and the compound of Formula IB comprises, and preferably comprises at least about 50% by weight, and more preferably comprises at least about 70% by weight, and even more preferably consists essentially of 2,3,3,3-tetrafluoropropene (1234yf).

For the purposes of illustration, reference is now made to FIGS. 1 and 2 showing a refrigerator appliance which includes a cabinet and is defined by an outer cabinet metal wall 1, an inner liner wall 2, and a body of foamed-in-place insulation 3 therebetween. It will be understood by those skilled in the art that the particular shape and configuration shown in FIGS. 1 and 2 is for illustration only and that numerous and various shapes and configurations of the cabinet, and therefore the cabinet liner wall 2, may be used within the broad scope of the present invention. In general, the thickness of the liner wall 2 is relevant to certain preferred embodiments of the present invention, but otherwise the particular shape and configuration of the cabinet formed by the liner wall can be according to any design as required for the particular application. In general, the inner liner wall 2 is thermoformed into the desired configuration, one example of which is shown in FIG. 2. Preferably, inner liner wall 2 is a thermoformed product of liner sheet made from one or more of the materials described herein, or a combination of sheets which have been laminated or otherwise integrated to form the liner wall 2.

Applicants have found that in highly preferred embodiments, including and preferably those in which the blowing agent is HCFO-1233zd(E), the liner of the present invention has a thickness of not greater than about 10 mm, more preferably not greater than about 5 mm, more preferably not greater than about 4 mm, and even more preferably in certain embodiments not greater than 3 mm, or the other preferred thicknesses described herein.

Applicants have come to appreciate that the present systems and devices, including household refrigerators and the like, have a number of attributes for refrigerants and blowing agents that can, if the right combination of materials can be identified, potentially produce excellent and unexpected advantage over previously used materials. These attributes include:

good environmental properties, with preferred materials exhibiting zero ozone depletion potential (ODP), and low global warming potential (GWP);

low order of toxicity;

high performance, specifically with respect to efficiency and capacity for refrigerant gases;

thermal performance for blowing agents;

non-flammable, or low flammability risk characteristics;

relatively low cost;

durability, including particularly resistance to liner degradation.

Illustrated in Table 1, certain preferred systems utilize HCFO-1233zd(E) (which is sometimes also referred to herein as “1233zd” or transHCFO-1233zd) as a blowing agent which exhibits physical properties similar to 245fa. It would be noted that the global warming potential (GWP) of HCFO-1233zd(E) is more than two orders of magnitude lower than that of currently utilized HFCs, and more than one order of magnitude lower than the present language in the EU F-Gas Regulation, and within the rationale of the EU WEEE Directive pertaining to household refrigerator/freezers, with a GWP less than 15.

TABLE 1
Low GWP materials Comparative Physical Properties

PUR Blowing Agents

| Property | 1233zd(E) | 245fa |
|---|---|---|
| Molecular Weight | <130 | 134 |
| Boiling Point (° C.) | 19 | 15.3 |
| LFL/UFL (vol %-air) | None | None |
| GWP (100 yr) | 17 | 858* |

*2007 Technical Summary. Climate Change 2007: The Physical Science Basis. Contribution of Working Group 1 to the Fourth Assessment Report of the Intergovernmental Panel on Climate Change.

Preferred forms of the present invention utilize the preferred blowing agents in the various polyurethane (PUR) applications, including appliance foams. PUR foam properties of lambda (k-factor), compressive strength, and dimensional stability derived from characterization of hand mix foams or foam panels prepared by means of a high pressure foam machine have evidenced efficacy of the present systems in comparison to systems using 245fa foams. Furthermore, applicants have come to appreciate that until a commercial refrigerator product has been manufactured under industrial conditions, and assessed for energy performance and ancillary performance in other aspects, for example, liner compatibility, adhesion to liner and metal cabinet and doors, freeze stability, and other quality aspects, the full value and performance of the system will not be fully understood.

The following non-limiting examples serve to illustrate the invention.

### EXAMPLES

### Materials and Methods

Compounding

Raw Material Preparation

All the raw materials except SAN (defined below) were weighed proportionally and premixed in a high-speed mixer, and then the pre-mixture obtained was fed to a twin-screw extruder. Raw material SAN was fed separately by the other feeder. The two feeders can control the feeding speed based on our setting value according to the formulation.

Compounding

All materials were fed to a twin-screw extruder, where they are melted, compounded and then extruded, pull striped, cooled, and pelletized to obtain resin pellets. To meet the requirements of easily processing for high rubber content co-polymer, including ABS in preferred embodiments ABS resin, and low yellow index property of final product, a screw configuration was used for the advantage of providing low shear force in the melting section but good dispersion ability in the mixing section. The parameters utilized for such screw configurations are set forth in Table A, below.

TABLE A
Screw parameters for Leistritz twin extruder (d: 27 mm, L/d: 36)

| | Individual | Total | | |
|---|---|---|---|---|
| Elements | element length | length | Remark | |
| GFA 2-15-30 | 30 | 30 | 108 | 1barrel |
| GFA 2-40-90 | 90 | 120 | 216 | 2barrel |
| GFA 2-40-90 | 90 | 210 | 324 | 3barrel |
| GFA 2-30-60 | 60 | 270 | 432 | 4barrel |
| GFA 2-30-60 | 60 | 330 | 540 | 5barrel |
| GFA 2-30-30 | 30 | 360 | 648 | 6barrel |
| KB 5-2-30-30° | 30 | 390 | 756 | 7barrel |
| KB 5-2-30-60° | 30 | 420 | 864 | 8barrel |
| KB 5-2-30-30° L | 30 | 450 | 972 | 9barrel |
| GFA 2-40-90 | 90 | 540 | 486 | side feeding |
| GFA 2-30-60 | 60 | 600 | 810 | vacuum |
| KB 5-2-30-30° | 30 | 630 | | |
| KB 5-2-30-30° | 30 | 660 | | |
| GFA 2-30-30 | 30 | 690 | | |
| GFA 2-30-30 | 30 | 720 | | |
| KB 5-2-30-60° | 30 | 750 | | |
| KB 5-2-30-60° L | 30 | 780 | | |
| 2 KB paddles | 20 | 800 | | |
| GFA 2-40-90 | 90 | 890 | | |
| GFA 2-30-60 | 60 | 950 | | |
| GFA 2-20-30 | 30 | 980 | | |

The barrel temperature of the twin-screw extruder is between 170° C. and 250° C., and rotation speed of the screws is between 300 and 600 rpm. According to certain preferred embodiments, higher temperatures were used in the melting section and lower temperatures in the mixing section. Applicants have found that this configuration reduces the degradation during processing, thus the obtained co-polymer, including ABS resins, will have better mechanical properties. Such preferred process conditions are set forth in Table B, below.

TABLE B
Process conditions

| | | | | | Tensile |
|---|---|---|---|---|---|
| | | | | Melt | strain |
| No | | Output | | temp | at break |
| # | Rpm | (Kg/h) | Temp (° C.) | (° C.) | (%) |
| 1 | 550 | 35 | B1: 170° C., B2-B8: 260° | 285 | 12.86 (9-18) |
| | | | C., DIE: 230° C. | | |
| 2 | 550 | 35 | B1: 170° C., B2-B8: 230° | 270 | 9.77 (5-17) |
| | | | C., DIE: 230° C. | | |
| 3 | 550 | 20 | B1: 170° C., B2-B8: 230° | 271 | 11.49 (8-14) |
| | | | C., DIE: 230° C. | | |
| 4 | 500 | 30 | B1: 170° C., B2-B4: 250° | 252 | 35.3 (25-49) |
| | | | C., B5-B8: 230° C., DIE: | | |
| | | | 230° C. | | |
| 5 | 500 | 40 | B1: 170° C., B2-B4: 250° | 251 | 32.1 (20-52) |
| | | | C., B5-B8: 230° C., DIE: | | |
| | | | 230° C. | | |

Injection Molding

The resin pellets prepared using the process above were dried at 85° C. for 4 h, and then molded into bars according to the ASTM standard. The temperature of the injection system was between 230° C. and 260° C., and the temperature of the mold was between 75 and 85° C. Typical parameter setting can be found in the below table.

TABLE C
Parameter Settings

| Temp setting | | | | |
|---|---|---|---|---|
| Z5 | Z4 | Z3 | Z2 | Z1 |
| 250 | 250 | 250 | 245 | 230 |

| Injection | 1300 | | | | | |
|---|---|---|---|---|---|---|
| pressure (kgf/c) | | | | | | |
| temp set for | 80 | | | | | |
| molding | | | | | | |
| machine | | | | | | |
| | | V-P | | | | |
| | | switch | 4th | 3rd | 2nd | 1st |
| Injection rate | position | 7 | 16 | / | / | / |
| | rate | 80 | 80 | 0 | 0 | 0 |

| | | 1st | 2nd | metering |
|---|---|---|---|---|
| Pre-plastic | position | / | 54 | 60 |
| | back pressure | / | 20 | 15 |
| | swing | / | 150 | 120 |
| Cooling time (S) | 17 s | | | |
| | 4th | 3rd | 2nd | 1st |
| Dwell time (S) | 0 | 0.5 | 0 | 6 |
| Pressure (kgf/c) | 0 | 50 | 0 | 650 |

ESCR (Environmental Stress Cracking Resistance) Test Method—10° C.

Jig: 2% flexural strain (ESCR test by constant strain method)

Specimen: Tensile bars according to ASTM D638 by injection molding

Procedures:
1. Fixed the bars into the jig;
2. Set the oven to 10° C.;
3. Put the jig into plastic bag and move them to the oven;
4. Pour 50 mL LBA onto a cloth in the bag after the bars cooled (the cloth did not contact the bars);
5. Remove the air in the bag as much as possible and then seal the bag;
6. Hold in the oven for 6 h;
7. Shut down the oven and let the temperature reach ambient naturally;
8. Observe the bars after 16 h.

ESCR (Environmental Stress Cracking Resistance) Test Method—−40° C.

Jig: 2% flexural strain (ESCR test by constant strain method)

Specimen: Tensile bars according to ASTM D638 by injection molding

Procedures:
1. Fixed the bars into the jig;
2. Set the chamber to −40° C.;
3. Put the jig into plastic bag and move them to the chamber and cover bars with a cotton cloth;
4. Pour 50 mL LBA onto the cloth in the bag after the bars cooled (the cloth did not contact the bars);
5. Remove the air in the bag as much as possible and then seal the bag;
6. Hold in the chamber for 20 h;
7. Shut down the chamber and let the temperature reach ambient naturally;
8. Observe the bars.

Tensile Test Method

The testing bars were injection molded. The Tensile test was done on Instron Universal Testing Machine at 23° C. according to ASTM D638. The tensile speed was 20 mm/min.

Raw Materials:

HRG: Unless otherwise indicated, the material designated as HRG comprises a plastic co-polymer of acrylonitrile and styrene with polybutadiene rubber grafted thereto in amounts of about 60% by weight based on the weight of the HRG material. In preferred embodiments and generally according to the examples, the particle size of the HRG, which is a form of an emulsion ABS, is between 0.1-0.4 um. The HRG used in the examples is designated HR-181 and comprises 60% by weight rubber.

SAN: Styrene acrylonitrile resin is a copolymer plastic consisting of styrene and acrylonitrile. It imparts plastic characteristics to the liners contemplated herein.

ASA: Acrylonitrile Styrene Acrylate (ASA)—ASA is produced by introducing a grafted acrylic ester elastomer during the copolymerization reaction between styrene and acrylonitrile. It can impart plastic characteristics to the liners contemplated herein.

Bulk ABS: The particle size of the bulk ABS is between 0.5-1 um.

EBS: Ethylene Bis Stearmide, grade: KAO WAX EB-FF

AO1076: antioxidant 1076, CAS number 2082-79-3, Octadecyl-3-(3,5-di-tert.butyl-4-hydroxyphenyl)-propionate,

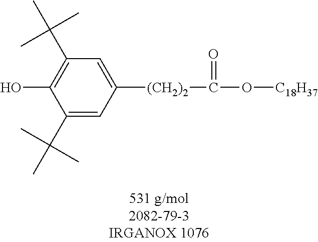

AO168: antioxidant 168, CAS number 31570-04-4, Tris(2,4-ditert-butylphenyl)phosphite

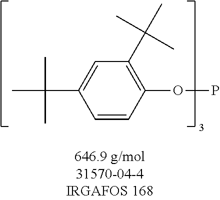

### Comparative Example 1

The below experiment of ESCR performance (at 10° C.) was conducted in accordance with the methods and materials. As noted in Table D below, the results showed that at 24% rubber, the ABS liner cracked.

TABLE D

| | Example 1 |
|---|---|
| | High Rubber ABS-1 |
| | HR-5 |
| | (wt, phr) |
| HRG (HR-181 from Kumho, Korea) | 40 |
| SAN (PN 137H from ChiMei) | 60 |
| EBS (grade?) | 1 |
| AO1076 | 0.15 |
| AO168 | 0.3 |
| Rubber Content based on the weight of ABS | 24% |
| ESCR Performance (10° C.) | crack |

### Examples 2-5—Different Rubber Content Series

The below series of experiments were conducted in accordance with the methods and materials above using increasing the rubber content and applicants found that for polymeric materials having 30% by weight of rubber improved ESCR performance. As noted in Table E below, the results confirmed that rubber content not less than 30% unexpectedly improved the ESCR performance to an unexpected extent.

TABLE E

| | Exam- | Exam- | Exam- | Exam- |
|---|---|---|---|---|
| | ple 2 | ple 3 | ple 4 | ple 5 |
| | High Rubber Material Based on HRG and SAN | | | |
| | HR-1 | HR-2 | HR-3 | HR-4 |
| | (wt, phr) | (wt, phr) | (wt, phr) | (wt, phr) |
| HRG (HR-181 from | 100 | 80 | 60 | 50 |
| Kumho, Korea) | | | | |
| SAN (PN 137H from | | 20 | 40 | 50 |
| ChiMei) | | | | |
| EBS (grade?) | 1 | 1 | 1 | 1 |
| AO1076 | 0.15 | 0.15 | 0.15 | 0.15 |
| AO168 | 0.3 | 0.3 | 0.3 | 0.3 |
| Rubber Content based | 60% | 48% | 36% | 30% |
| on the weight of ABS | | | | |
| ESCR Performance | no crack | no crack | no crack | no crack |
| (10° C.) | | | | |

### Comparative Examples 6-8—Different Rubber Content Series

The below series of ESCR tests (10° C.) were conducted in accordance with the materials and methods above but utilized amounts of rubber moieties less than 305 by weight. As noted below in Table F, all compositions tested resulted in liner cracking.

TABLE F

| | Low Rubber Polymeric Material | | |
|---|---|---|---|
| | Example 6 | Example 7 | Example 8 |
| | Designation | | |
| | 20140913-3 | 20140913-2 | OHR-1 |
| | Wt, phr | Wt, phr | Wt, phr |
| HRG (HR-181 from Kumho, | 48 | 44 | 41.5 |
| Korea) | | | |
| SAN (PN 137H from ChiMei) | 52 | 56 | 58.5 |
| TiO2 | | | 4 |
| EBS | 1.2 | 1.2 | 1 |
| AO1076 | 0.2 | 0.2 | 0.15 |
| AO168 | 0.4 | 0.4 | 0.3 |
| Rubber Content based on the | 29% | 26% | 24.9% |
| weight of ABS | | | |
| ESCR Performance (10° C.) | crack | Crack | Crack |

### Examples 9-11—Different Rubber Content Series

The below series of experiments were conducted in accordance with the materials and methods above in accordance with the present invention and demonstrated the unexpected and highly advantageous result of the present invention amounts of rubber not less than about 30% by weight produce a liner material that is capable of passing the ESCR test.

TABLE G

| | Example 9 | Example 10 | Example 11 |
|---|---|---|---|
| | High Rubber ABS-2 | | |
| | OCHR-1 | OCHR-2 | OCHR-3 |
| | wt, phr | Wt, phr | Wt, phr |
| HRG (HR-181 from Kumho, | 58.5 | 54 | 50 |
| Korea) | | | |
| SAN (PN 137H from | 41.5 | 46 | 50 |
| ChiMei) | | | |
| TiO2 | 3 | 3 | 3 |
| EBS | 1 | 1 | 1 |
| AO1076 | 0.15 | 0.15 | 0.15 |
| AO168 | 0.3 | 0.3 | 0.3 |
| Rubber Content based on the | 35.10% | 32.40% | 30% |
| weight of ABS | | | |
| ESCR Performance (10° C.) | no crack | no crack | no crack |

### Examples 12-14—Blended Rubber Series

Generally, particle size of the HRG (emulsion ABS) is between 0.1-0.4 um and particle size of the bulk ABS is between 0.5-1 um. The below series of experiments were conducted in accordance with the materials and methods above to find out the influence of particle size on ESCR performance (10° C.). As demonstrated in Table H below, the results showed that blended rubber also worked when the rubber content was higher than 30%. Rubber from bulk ABS had similar effect with rubber from emulsion ABS.

TABLE H
Blended Rubber Series

| | Example 12 | Example 13 | Example 14 |
|---|---|---|---|
| | Blended Rubber ABS | | |
| | BR-1 | BR-2 | BR-3 |
| | (wt, phr) | (wt, phr) | (wt, phr) |
| HRG (HR-181 from Kumho, | 70 | 50 | 30 |
| Korea) | | | |
| Bulk ABS (Gaoqiao 275) | 30 | 50 | 70 |
| EBS | 1 | 1 | 1 |
| AO1076 | 0.15 | 0.15 | 0.15 |
| AO168 | 0.3 | 0.3 | 0.3 |
| Small Rubber from HRG | 42% | 30% | 18% |
| Large Rubber from Bulk | 5.4% | 9% | 12.6% |
| ABS | | | |
| Total Rubber Content | 47.40% | 39% | 30.60% |
| based on the weight of | | | |
| ABS | | | |
| ESCR Performance (10° C.) | no crack | no crack | no crack |

### Examples 15-17—Different SAN Series

The below series of experiments were conducted in accordance with the materials and methods above to find out the influence of SAN on ESCR performance (10° C.). The results are reported below in Table I and demonstrate that different SAN worked when the rubber content was higher than 30%, as is the case with each of the materials of the table below.

TABLE I
Different SAN Series

| | Example 15 | Example 16 | Example 17 |
|---|---|---|---|
| | Different SAN ABS | | |
| | OHR-2 | OHR-4 | OHR-5 |
| | Wt, phr | Wt, phr | Wt, phr |
| HRG (HR-181 from Kumho, | 50 | 50 | 50 |
| Korea) | | | |
| SAN (PN 137H from ChiMei) | 50 | | |
| SAN AS-81 (from Jihua) | | 50 | |
| SAN AS-30 (from Jihua) | | | 50 |
| TiO2 | 4 | 4 | 4 |
| EBS | 1 | 1 | 1 |
| AO1076 | 0.15 | 0.15 | 0.15 |
| AO168 | 0.3 | 0.3 | 0.3 |
| Rubber Content based | 30% | 30% | 30% |
| on the weight of ABS | | | |
| ESCR Performance (10° C.) | No crack | No crack | No crack |

TABLE J
Relative Molecular Weight

| Sample ID/Main Peak | Mₙ | M_{w} | (M_{w}/Mₙ) |
|---|---|---|---|
| AS-PN-137H | 49546 | 86249 | 1.74 |
| AS-30 | 59192 | 124493 | 2.10 |
| AS-81 | 57537 | 118472 | 2.06 |

AN content of SAN is 137H>AS-81>AS-30 according to FTIR results.

### Comparative Examples 18-20—Modified Commercial ABS

The below series of ESCR tests (10° C.) experiments were conducted in accordance with the materials and methods above but without using a minimum rubber content of 30% according to the present invention. Each of the formulations in Table K below had a rubber content of substantially less than 30%.

TABLE K

| | Example 18 | Example 19 | Example 20 |
|---|---|---|---|
| | Modified Commercial ABS | | |
| | ES-0173 | Gaoqiao 275 | CR9020 |
| | Wt, phr | Wt, phr | Wt, phr |
| SAN (PN 137H | | | |
| from ChiMei) | | | |
| ABS ES-0173 | 100 | | |
| (from Samsung | | | |
| Cheil) | | | |
| Bulk ABS | | 100 | |
| Gaoqiao 275 | | | |
| ASA CR9020 | | | 100 |
| from Sabic | | | |
| TiO2 | | | |
| EBS | | | |
| AO1076 | | | |
| AO168 | | | |
| ESCR | crack | crack | crack |
| Performance | | | |
| (10° C.) | | | |

### Examples 18-24—Modified Commercial ABS

The below series of experiments were conducted in accordance with the materials and methods above to show that commercial ABS and ASA can be used to produce a modified polymeric material of the present invention that has at least a rubber content of 30% by weight and that such modified materials possess the unexpected ESCR performance (10° C.) according to the preferred aspects of the present invention. These result are reported in Table L below and may be compared with the results in Table K, above. These results also show that the present invention may use of ASA as one of the co-polymer chains to provide rubber moieties in form of acrylate rubber and provides similar performance as when ABS is used as one of the co-polymer chain to provide rubber moieties in the form of butadiene rubber.

TABLE L

| | Exam- | Exam- | Exam- | Exam- |
|---|---|---|---|---|
| | ple 21 | ple 22 | ple 23 | ple 24 |
| | Modified Commercial ABS | | | |
| | OCHR-6 | BR-3 | OHR-6 | OHR-7 |
| | Wt, phr | Wt, phr | Wt, phr | Wt, phr |
| HRG (HR-181 from | 20 | 30 | 41.5 | 41.5 |
| Kumho, Korea) | | | | |
| SAN (PN 137H | | | 33.5 | 33.5 |
| from ChiMei) | | | | |
| ABS ES-0173 | 80 | | | |
| (from Samsung | | | | |
| Cheil) | | | | |
| Bulk ABS | | 70 | 25 | |
| Gaoqiao 275 | | | | |
| ASA CR9020 | | | | 25 |
| from Sabic | | | | |
| TiO2 | 1.5 | | 4 | 4 |
| EBS | 1 | 1 | 1 | 1 |
| AO1076 | 0.15 | 0.15 | 0.15 | 0.15 |
| AO168 | 0.3 | 0.3 | 0.3 | 0.3 |
| ESCR | no crack | no crack | no crack | no crack |
| Performance | | | | |
| (10° C.) | | | | |

### Example 25—Tensile Test Results at 23° C. According to ASTM D638

The below series of experiments were conducted in accordance with the materials and methods above, and using the compositions of Examples 1-24, above, to demonstrate the tensile test results of each composition at 23° C. and according to ASTM D638. Results are provided below in Table M.

TABLE M

| | | | | | Tensile | Tensile | Tensile | Tensile |
|---|---|---|---|---|---|---|---|---|
| | | | Tensile | Tensile | Stress @ | Strain @ | Stress @ | Strain @ |
| | Example | Sample | Speed | Modulus | Yield | Yield | Break | Break |
| Series | Comp. | ID | (mm/min) | (MPa) | (MPa) | (%) | (MPa) | (%) |
| High | Example 1 | HR-5 | 20 | 1973 | 39.0 | 2.7 | 32.6 | 5 |
| Rubber | Example 2 | HR-1 | 20 | 537 | 9.3 | 3.6 | 9.8 | 89 |
| ABS-1 | Example 3 | HR-2 | 20 | 855 | 16.4 | 4.1 | 16.4 | 100 |
| | Example 4 | HR-3 | 20 | 1372 | 25.9 | 3.5 | 21.3 | 52 |
| | Example 5 | HR-4 | 20 | 1685 | 33.3 | 3.1 | 27.0 | 8 |
| High | Example 6 | 201409 | 20 | 1574 | 33.8 | 3.3 | 25.8 | 17 |
| Rubber | | 19-3 | | | | | | |
| ABS-2 | Example 7 | 201409 | 20 | 1896 | 35.5 | 2.8 | 28.1 | 8 |
| | | 19-2 | | | | | | |
| | Example 8 | OHR-1 | 20 | 1978 | 36.2 | 2.7 | 29.2 | 5 |
| | Example 9 | OCHR-1 | 20 | 1645 | 25.9 | 3.3 | 21.6 | 57 |
| | Example | OCHR-2 | 20 | 1366 | 29.4 | 3.6 | 23.1 | 29 |
| | 10 | | | | | | | |
| | Example | OCHR-3 | 20 | 1450 | 31.2 | 3.5 | 24.5 | 41 |
| | 11 | | | | | | | |
| Blended | Example | BR-1 | 20 | 839 | 16.5 | 3.6 | 16.1 | 97 |
| Rubber | 12 | | | | | | | |
| ABS | Example | BR-2 | 20 | 1111 | 22.2 | 3.6 | 19.6 | 68 |
| | 13 | | | | | | | |
| | Example | BR-3 | 20 | 1511 | 28.8 | 2.6 | 23.6 | 21 |
| | 14 | | | | | | | |
| Different | Example | OHR-2 | 20 | 1550 | 31.7 | 3.3 | 25.9 | 5 |
| SAN | 15 | | | | | | | |
| ABS | Example | OHR-4 | 20 | 1611 | 31.4 | 2.8 | 26.6 | 5 |
| | 16 | | | | | | | |
| | Example | OHR-5 | 20 | 1868 | 31.6 | 2.6 | 26.6 | 6 |
| | 17 | | | | | | | |
| Modified | Example | ES-0173 | 20 | 2926 | 39.1 | 2.3 | 30.3 | 24 |
| Commercial | 18 | | | | | | | |
| ABS | Example | Gaoqiao | 20 | 2142 | 41.0 | 2.5 | 31.5 | 36 |
| | 19 | 275 | | | | | | |
| | Example | CR9020 | 20 | 2404 | 46.5 | 3.1 | 32.0 | 10 |
| | 20 | | | | | | | |
| | Example | OCHR-6 | 20 | 1762 | 32.2 | 3.3 | 26.7 | 36 |
| | 21 | | | | | | | |
| | Example | BR-3 | 20 | 1511 | 28.8 | 2.6 | 23.6 | 21 |
| | 22 | | | | | | | |
| | Example | OHR-6 | 20 | 1761 | 29.9 | 2.7 | 24.1 | 7 |
| | 23 | | | | | | | |
| | Example | OHR-7 | 20 | 1718 | 31.2 | 3.1 | 25.0 | 5 |
| | 24 | | | | | | | |

### Example 26—Line Trial

Based on the above results, the ESCR test showed the material was not cracked when the rubber content was higher than 30 wt %. The formulation below in Table N, was chosen for a line trial.

TABLE N

| High Rubber ABS | SHL Wt, phr |
|---|---|
| HRG (HR-181 from Kumho, | 50 |
| Korea) | |
| SAN (PN 137H from ChiMei) | 50 |
| TiO2 | 4.0 |
| EBS | 1 |
| AO1076 | 0.1 |
| AO168 | 0.2 |

The ABS SHL with above formulation was extruded into 3.9 mm-thickness sheet by a single screw extruder with a diameter of 120 mm. There was no issue for sheet extrusion. Table 0, below, provides the parameters for extrusion.

TABLE O

| | | | | Actual | | | | Actual |
|---|---|---|---|---|---|---|---|---|
| | | Set point | | feedback | | Set point | | feedback |
| Temperature | Extruder | Z1 | 190 | 242 | die | 1# | 220 | 220 |
| for each part | (d: 120 mm) | Z2 | 195 | 250-251 | | 2# | 213 | 213-214 |
| (° C.) | | Z3 | 200 | 217-218 | | 3# | 230 | 233-234 |
| | | Z4 | 180 | 218-219 | | 4# | 221 | 240-241 |
| | | Z5 | 200 | 191-199 | | 5# | 220 | 226 |
| | | Z6 | 210 | 210 | | 6# | 216 | 216-217 |
| | | Z7 | 220 | 238-239 | | 7# | 222 | 238-239 |
| | pump area | | 220 | 225 | | 8# | 225 | 227-229 |
| | Distributor | 1# | 220 | 220 | | 9# | 218 | 218 |
| | | 2# | 220 | 228 | top roll | | 75 | 75 |
| | screen | 1# | 220 | 220 | middle roll | | 71 | 71 |
| | changer | 2# | 220 | 220 | bottom roll | | 65 | 64 |
| | area | | | | | | | |

| | | | |
|---|---|---|---|
| Other | Main | Rotation | 79-88 |
| parameters | extruder | rate (Rpm) | |
| | | Electricity | 243-269 |
| | | current (A) | |
| | Pump | Rotation | 49.8 |
| | | rate (Rpm) | |
| | | Electricity | 17.4 |
| | | current (A) | |

Thermoforming Parameter—Tough the ABS had some problems when it thermoformed to liner, some liners were also assembled and foamed to obtain refrigerators for thermal cycle. Generally, the thermal cycle started from room temperature with all liners being exposed to the ambient conditions (i.e. the refrigerator/freezer door was open or removed). The chamber was cooled to −40° C., holding for 4 h, then heated to 70° C. All refrigerators were then held for 4 h at 70° C. The temperature was then allowed to return to room temperature. 2 h was needed for heating or cooling between −40° C. and 70° C. 1 cycle required 12 h total.

Trial results—The line trial results showed ABS SHL passed the first cycle. All the other commercial grade ABS failed in the first cooling cycle (−40° C. to 70° C.), as illustrated in Table P, below.

TABLE P

| | SHL-1 | ES173 |
|---|---|---|
| Small crack | 5 | 2 |
| Long crack | 1 | 13 |

### Example 27—Line Trial

In accordance with the parameters of Example 26, the composition of Example 2 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 28—Line Trial

In accordance with the parameters of Example 26, the composition of Example 3 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 29—Line Trial

In accordance with the parameters of Example 26, the composition of Example 4 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 30—Line Trial

In accordance with the parameters of Example 26, the composition of Example 5 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 31—Line Trial

In accordance with the parameters of Example 26, the composition of Example 9 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 32—Line Trial

In accordance with the parameters of Example 26, the composition of Example 10 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 33—Line Trial

In accordance with the parameters of Example 26, the composition of Example 11 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 34—Line Trial

In accordance with the parameters of Example 26, the composition of Example 12 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 35—Line Trial

In accordance with the parameters of Example 26, the composition of Example 13 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 36—Line Trial

In accordance with the parameters of Example 26, the composition of Example 14 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 37—Line Trial

In accordance with the parameters of Example 26, the composition of Example 15 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 38—Line Trial

In accordance with the parameters of Example 26, the composition of Example 16 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 39—Line Trial

In accordance with the parameters of Example 26, the composition of Example 17 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 40—Line Trial

In accordance with the parameters of Example 26, the composition of Example 21 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 41—Line Trial

In accordance with the parameters of Example 26, the composition of Example 22 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 42—Line Trial

In accordance with the parameters of Example 26, the composition of Example 23 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Example 43—Line Trial

In accordance with the parameters of Example 24, the composition of Example 24 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 26. No significant cracking is observed.

### Comparative Examples 44-58

The below experiment of ESCR performance (at −40° C.) was conducted in accordance with the methods and materials and using various thermoplastic plastomers/elastomers. Results are provided below in Tables Q-S for AX8900 series (25 wt % acrylate and 8 wt % GMA, MFI: 6 (190° C./2.16 kg)) from Arkema); EVA series; and PTW series (from DuPont), respectively.

TABLE Q

| | Example | | | | |
|---|---|---|---|---|---|
| | Example | Example | Example | Example | Example |
| | 44 | 45 | 46 | 47 | 48 |
| | AX8900 series | | | | |
| | AX-3 | AX-4 | AX-6 | AX-7 | AX-8 |
| | 20141118- | 20141124- | 20141124- | 20141126- | 20141120- |
| | 2 | 2 | 1 | 1 | 4 |
| HRG | 44 | 44 | 40 | 35 | 30 |
| SAN | 56 | 56 | 60 | 65 | 70 |
| AX8900 | 2.5 | 1 | 2.5 | 5 | 5 |
| EBS | 1 | 1 | 1 | 1 | 1 |
| AO1076 | 0.15 | 0.15 | 0.15 | 0.15 | 0.15 |
| AO168 | 0.3 | 0.3 | 0.3 | 0.3 | 0.3 |
| ESCR | crack | Crack | long cracks | very short | crack |
| Perfor- | | | | cracks on | |
| mance | | | | the edge | |

TABLE R

| Examples | Example 49 | Example 50 | Example 51 | Example 52 | Example 53 | Example 54 |
|---|---|---|---|---|---|---|
| EVA series | EVA-1 | EVA-2 | EVA-4 | EVA-5 | EVA-6 | EVA-7 |
| | 20141111-2 | 20141126-3 | 20141117-6 | 20141124-3 | 20141120-3 | 20141118-4 |
| HRG | 44 | 35 | 44 | 40 | 30 | 44 |
| SAN | 56 | 65 | 56 | 60 | 70 | 56 |
| EVM50 | 10 | 5 | | | | |
| EVA33 | | | 5 | 10 | 10 | |
| EVA14 | | | | | | 10 |
| EBS | 1 | 1 | 1 | 1 | 1 | 1 |
| AO1076 | 0.15 | 0.15 | 0.15 | 0.15 | 0.15 | 0.15 |
| AO168 | 0.3 | 0.3 | 0.3 | 0.3 | 0.3 | 0.3 |
| ESCR | crack | Crack | crack | Crack | crack | crack |
| Performance | | | | | | |

TABLE S

| | Examples | | | |
|---|---|---|---|---|
| | Example 55 | Example 56 | Example 57 | Example 58 |
| | PTW series | | | |
| | PTW-3 | PTW-4 | PTW-5 | PTW-6 |
| | 20141118-3 | 20141124-4 | 20141120-1 | 20141120-2 |
| HRG | 44 | 40 | 30 | 20 |
| SAN | 56 | 60 | 70 | 80 |
| PTW | 2.5 | 10 | 5 | 5 |
| EBS | 1 | | | |
| AO1076 | 0.15 | | | |
| AO168 | 0.3 | | | |
| ESCR | short crack | crack | Crack | crack |
| Performance | | | | |

### Examples 59-64—40° C. ESCR Test Results

The below series of experiments were conducted in accordance with the methods and materials above to establish that greater than 30% rubber content results in ESCR performance (−40° C.) that demonstrates no cracking. Results are provided in Tables T-V for AX8900 series (25 wt % acrylate and 8 wt % GMA, MFI: 6 (190° C./2.16 kg)) from Arkema); EVA series; and PTW series (from DuPont), respectively.

TABLE T

| | Examples | | |
|---|---|---|---|
| | Example 59 | Example 60 | Example 61 |
| | AX8900 series | | |
| | AX-1 | AX-2 | AX-5 |
| | 20141111-1 | 20141117-4 | 20141126-5 |
| HRG | 44 | 44 | 40 |
| SAN | 56 | 56 | 60 |
| AX8900 | 10 | 5 | 7.5 |
| EBS | 1 | 1 | 1 |
| AO1076 | 0.15 | 0.15 | 0.15 |
| AO168 | 0.3 | 0.3 | 0.3 |
| ESCR Performance | no obvious | no obvious | no obvious |
| | crack | crack | crack |

TABLE U

| | Example |
|---|---|
| | Example 62 |
| | EVA series |
| | EVA-3 |
| | 20141111-5 |
| HRG | 44 |
| SAN | 56 |
| EVM50 | |
| EVA33 | 10 |
| EVA14 | |
| EBS | 1 |
| AO1076 | 0.15 |
| AO168 | 0.3 |
| ESCR Performance | no obvious |
| | crack |

TABLE V

Examples

| | |
|---|---|
| Example 63 | Example 64 |

PTW series

| | PTW-1 | PTW-2 |
|---|---|---|
| | 20141111-3 | 20141117-5 |
| HRG | 44 | 44 |
| SAN | 56 | 56 |
| PTW | 10 | 5 |
| EBS | 1 | 1 |
| AO1076 | 0.15 | 0.15 |
| AO168 | 0.3 | 0.3 |
| ESCR Performance | no obvious | no obvious |
| | crack | crack |

### Example 65—Tensile Test Results (23° C., ASTM D638)

The below series of experiments were conducted in accordance with the materials and methods above, and using the compositions of Example 44-64, above, to demonstrate the tensile test results of each composition at 23° C. and according to ASTM D638. Results are provided below in Tables W-Y.

TABLE W

| | | Ten- | Ten- | Tensile | Tensile | Tensile | Tensile |
|---|---|---|---|---|---|---|---|
| | | sile | sile | Stress | Strain | Stress | Strain |
| | | Speed | Mod- | @ | @ | @ | @ |
| | Sample | (mm/ | ulus | Yield | Yield | Break | Break |
| | ID | min) | (MPa) | (MPa) | (%) | (MPa) | (%) |
| AX-1 | 20141111-1 | 20 | 1168 | 22.2 | 4.00 | 24.3 | 64 |
| | (Ex. 59) | | | | | | |
| AX-2 | 20141117-4 | 20 | 1420 | 28.0 | 4.21 | 26.7 | 65 |
| | (Ex. 60) | | | | | | |
| AX-3 | 20141118-2 | 20 | 1492 | 31.3 | 3.79 | 26.1 | 36 |
| | (Ex. 44) | | | | | | |
| AX-4 | 20141124-2 | 20 | 1917 | 34.7 | 3.08 | 28.2 | 10 |
| | (Ex. 45) | | | | | | |
| AX-5 | 20141126-5 | NA | NA | NA | NA | NA | NA |
| | (Ex. 61) | | | | | | |
| AX-6 | 20141124-1 | 20 | 1694 | 35.1 | 3.20 | 29.0 | 25 |
| | (Ex. 46) | | | | | | |
| AX-7 | 20141126-1 | 20 | 1580 | 31.6 | 2.95 | 29.7 | 67 |
| | (Ex. 47) | | | | | | |
| AX-8 | 20141120-4 | 20 | 1842 | 33.9 | 2.54 | 31.9 | 63 |
| | (Ex. 48) | | | | | | |

TABLE X

| | | Ten- | Ten- | Tensile | Tensile | Tensile | Tensile |
|---|---|---|---|---|---|---|---|
| | | sile | sile | Stress | Strain | Stress | Strain |
| | | Speed | Mod- | @ | @ | @ | @ |
| | Sample | (mm/ | ulus | Yield | Yield | Break | Break |
| | ID | min) | (MPa) | (MPa) | (%) | (MPa) | (%) |
| EVA-1 | 20141111-2 | 20 | 1478 | 27.1 | 3.48 | 23.6 | 63 |
| | (Ex. 49) | | | | | | |
| EVA-2 | 20141126-3 | 20 | 1834 | 35.8 | 2.68 | 28.4 | 21 |
| | (Ex. 50) | | | | | | |
| EVA-3 | 20141111-5 | 20 | 1469 | 28.0 | 3.53 | 23.9 | 79 |
| | (Ex. 62) | | | | | | |
| EVA-4 | 20141117-6 | 20 | 1812 | 33.0 | 3.22 | 26.3 | 33 |
| | (Ex. 51) | | | | | | |
| EVA-5 | 20141124-3 | 20 | 1618 | 31.8 | 3.35 | 27.5 | 80 |
| | (Ex. 52) | | | | | | |
| EVA-6 | 20141120-3 | 20 | 1938 | 37.1 | 2.81 | 28.6 | 43 |
| | (Ex. 53) | | | | | | |
| EVA-7 | 20141118-4 | | | | | | |
| | (Ex. 54) | 20 | 1466 | 29.7 | 3.54 | 22.1 | 16 |

TABLE Y

| | | Ten- | Ten- | Tensile | Tensile | Tensile | Tensile |
|---|---|---|---|---|---|---|---|
| | | sile | sile | Stress | Strain | Stress | Strain |
| | | Speed | Mod- | @ | @ | @ | @ |
| | Sample | (mm/ | ulus | Yield | Yield | Break | Break |
| | ID | min) | (MPa) | (MPa) | (%) | (MPa) | (%) |
| PTW-1 | 20141111-3 | 20 | 1299 | 24.1 | 4.63 | 25.7 | 83 |
| | (Ex. 63) | | | | | | |
| PTW-2 | 20141117-5 | 20 | 1411 | 28.6 | 3.99 | 26.3 | 71 |
| | (Ex. 64) | | | | | | |
| PTW-3 | 20141118-3 | 20 | 1609 | 32.9 | 3.34 | 27.9 | 6 |
| | (Ex. 55) | | | | | | |
| PTW-4 | 20141124-4 | 20 | 1532 | 31.5 | 3.60 | 28.5 | 64 |
| | (Ex. 56) | | | | | | |
| PTW-5 | 20141120-1 | 20 | 1980 | 35.7 | 2.47 | 32.6 | 76 |
| | (Ex. 57) | | | | | | |
| PTW-6 | 20141120-2 | 20 | 2370 | 41.4 | 2.22 | 36.3 | 55 |
| | (Ex. 58) | | | | | | |

### Example 66—Line Trial

In accordance with Example 26, the composition provided was modified to include a thermoplastic plastomer/elastomer resin. The formulation in Example 26 is provided below in Table Z and is labeled SHL-1, the modified (or second) formulation is the SHL-2.

TABLE Z

| ABS Formulation | SHL -1 Wt, phr | SHL-2 Wt, phr |
|---|---|---|
| HRG | 51.7 | 40 |
| SAN | 48.3 | 60 |
| AX8900 | | 5 |
| TiO2 | 3.0 | 3.0 |
| EBS | 1.2 | 1.0 |
| AO1076 | 0.15 | 0.15 |
| AO168 | 0.3 | 0.3 |

SHL-1 and SHL-2 were extruded into 3.9 mm-thickness sheet by a single screw extruder with a diameter of 120 mm. There is no issue for sheet extrusion. Table AA, below, provides the parameters for extrusion.

TABLE AA

| | | ES173 | | SHL-1 | | SHL-2 | |
|---|---|---|---|---|---|---|---|
| | | | Ac- | | Ac- | | Ac- |
| | | | tual | | tual | | tual |
| | | Set | feed- | Set | feed- | Set | feed- |
| | | point | back | point | back | point | back |
| Main | Z1 | 190 | 239 | 190 | 242 | 185 | 236 |
| Extruder(d = | Z2 | 195 | 245 | 195 | 250 | 190 | 227 |
| 120) | Z3 | 200 | 213 | 200 | 216 | 195 | 204 |
| | Z4 | 180 | 217 | 180 | 219 | 175 | 206 |
| | Z5 | 200 | 201 | 200 | 199 | 210 | 210 |
| | Z6 | 210 | 211 | 210 | 210 | 215 | 216 |
| | Z7 | 220 | 235 | 220 | 238 | 220 | 232 |
| screen changer | 1# | 220 | 220 | 220 | 220 | 230 | 230 |
| area | 2# | 220 | 220 | 220 | 220 | 230 | 225 |
| Connection 1 | | 220 | 168 | 220 | 128 | | |
| metering pump | | 220 | 221 | 220 | 225 | 230 | 230 |
| Connection 2 | | 215 | 196 | 215 | 203 | | |
| Distributor | 1# | 220 | 220 | 220 | 220 | 220 | 220 |
| | 2# | 220 | 228 | 220 | 228 | 220 | 229 |
| die | 1# | 200 | 199 | 220 | 219 | 215 | 214 |
| | 2# | 203 | 203 | 213 | 213 | 222 | 221 |
| | 3# | 228 | 228 | 230 | 233 | 238 | 238 |
| | 4# | 221 | 234 | 221 | 240 | 242 | 242 |
| | 5# | 220 | 222 | 220 | 226 | 225 | 227 |
| | 6# | 216 | 216 | 216 | 217 | 223 | 223 |
| | 7# | 222 | 232 | 222 | 238 | 241 | 242 |
| | 8# | 220 | 218 | 225 | 226 | 230 | 231 |
| | 9# | 200 | 200 | 218 | 216 | 220 | 220 |
| Roll | Top | 75 | 75 | 75 | 75 | 100 | 96 |
| | Middle | 71 | 71 | 71 | 71 | 78 | 78 |
| | Bottom | 65 | 64 | 65 | 64 | 68 | 67 |

| | | | | |
|---|---|---|---|---|
| Main extruder | Rotation | 83.4 | 81.2 | 79 |
| | speed | | | |
| | (Rpm) | | | |
| | Current(A) | 262.4 | 262.8 | 270 |
| Metering | Rotation | 51.0 | 49.8 | 50.0 |
| Pump | speed | | | |
| | (Rpm) | | | |
| | Current(A) | 17.8 | 17.4 | |
| Melt | 120 | 34 | 36 | |
| temperature | 60 | 145 | 214 | |
| Pressure at | 120 | 13.2 | 13.4 | |
| filter | 60 | 0.0 | 0.0 | |

Thermoforming Parameter—The thermal cycle started from room temperature with all liners being exposed to the ambient conditions (i.e. the refrigerator/freezer door was open or removed). The chamber was cooled to −40° C. or −30° C., holding for 4 h, then heated to 70° C. or 60° C., respectively. All refrigerators were then held for 4 h at 70° C. or 60° C. The temperature was then allowed to slowly room temperature. 2 h was needed for heating or cooling between −40° C. and 70° C. or between −30° C. and 60° C. 1 cycle required 12 h total. As indicated below, compositions were tested with R-141b and LBA (HCFO-1233zd(E), which are blowing agents used in thermal insulation.

Trial results—Results of the line trials are provided below in Table AB. The following summarizes these results.

>50% fresh food compartment of SHL-2/LBA passed the test, which is similar to the ES173/141b performance.

For all 6 SHL-2/LBA fresh food compartment, #5, #12, and #13 (from Table AB, below) had no crack after four −40° C./70° C. cycles or four −30° C./60° C.+two −40° C./70° C. cycles; #6 (from Table AB, below) only had one small crack (3 cm) and appeared at the last cycle after four −40° C./70° C. cycles.

SHL-2 with LBA foam performed better than ES173 with LBA foam, similar performance with ES173 and 141b foam was noted.

ES173/141b also had cracks, especially #2 and #9 (from Table AB, below), although ES173 had been widely used for 141b.

It was also noted that freezer compartments crack more frequently than fresh food compartment.

TABLE AB

| | | | Crack length (position)/cm (“L”—Freezer compartment | | | | | | | | | | | | | | |
|---|---|---|---|---|---|---|---|---|---|---|---|---|---|---|---|---|---|
| | | | or “R”—Fresh food compartment) | | | | | | | | | | | | | | |
| | | | 1/23 | 1/23 | 1/24 | 1/24 | 1/25 | 1/25 | 1/26 | 1/26 | 1/26 | 1/27 | 1/27 | 1/27 | 1/28 | 1/28 | 1/28 |
| | | | −40° | 70° | −40° | −30° | 60° | −30° | 60° | −30° | 60° | −30° | 70° | −40° | 70° | −40° | 70° |
| # | Liner | BA | C. | C. | C. | C. | C. | C. | C. | C. | C. | C. | C. | C. | C. | C. | C. |
| 1 | ES173 | 141b | — | 20(L)^{a} | — | | | | | | | | | | | | |
| 2 | ES173 | 141b | — | — | 40(R) | | | | | | | | | | | | |
| | | | | | 55(R) | | | | | | | | | | | | |
| | | | | | 55(R) | | | | | | | | | | | | |
| 3 | ES173 | 141b | — | — | 3(L) | | | | | | | | — | — | — | — | — |
| 4 | SHL-2 | LBA | — | — | 0.5(R) | | | | | | | | — | 27(R) | — | 4(L) | — |
| 5 | SHL-2 | LBA | — | — | 15(L) | | | | | | | | — | 3(L) | — | 11(L) | — |
| 6 | SHL-2/ | LBA | — | — | 40(L) | | | | | | | | — | — | — | 3(R) | — |
| | ES173^{b} | | | | | | | | | | | | | | | | |
| 7 | ES173 | LBA | 3(L) | — | 50(R) | | | | | | | | | | | | |
| | | | | | 105(L) | | | | | | | | | | | | |
| | | | | | 38(L) | | | | | | | | | | | | |
| | | | | | 32(L) | | | | | | | | | | | | |
| 8 | ES173 | 141b | | | | — | — | 24(L) | — | — | — | — | — | — | — | 17(L) | — |
| 9 | ES173 | 141b | | | | — | — | 20(L) | — | — | — | — | — | 50(L)^{c} | — | 40(L) | — |
| | | | | | | | | | | | | | | 15(L) | | 16(L) | |
| | | | | | | | | | | | | | | 45(R) | | 17(L) | |
| | | | | | | | | | | | | | | 18(R) | | 32(L) | |
| | | | | | | | | | | | | | | | | 67(L) | |
| | | | | | | | | | | | | | | | | 20(R) | |
| | | | | | | | | | | | | | | | | 34(R) | |
| | | | | | | | | | | | | | | | | 8(R) | |
| 10 | ES173 | 141b | | | | — | — | | — | — | — | — | — | 6(L) | — | — | — |
| 11 | SHL-2 | LBA | | | | — | — | — | — | — | — | 3(L) | — | 20(L) | — | 23(R) | — |
| | | | | | | | | | | | | 0.5(R) | | 2(L) | | 30(R) | |
| | | | | | | | | | | | | 0.5(R) | | | | | |
| 12 | SHL-2 | LBA | | | | — | — | | — | 5(L) | — | — | — | 100(L) | — | — | — |
| | | | | | | | | | | | | | | 20(L) | | | |
| | | | | | | | | | | | | | | 33(L) | | | |
| 13 | SHL-2/ | LBA | | | | — | — | 20(L) | — | — | — | — | — | 50(L) | — | — | — |
| | ES173^{b} | | | | | | | 27(L) | | | | | | 12(L) | | | |
| | | | | | | | | 45(L) | | | | | | 16(L) | | | |
| | | | | | | | | | | | | | | 15(L) | | | |

Notes:
^{a}Could be miss counted in early −40° C. stage.
^{b}Unit #6 & #13 use ES173 as freezer compartment liner and SHL-2 as fresh food compartment liner.
^{c}Grew from early 20(L) crack.

### Example 67—Line Trial

In accordance with the parameters of Example 66, the composition of Example 59 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 68—Line Trial

In accordance with the parameters of Example 66, the composition of Example 60 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 69—Line Trial

In accordance with the parameters of Example 66, the composition of Example 61 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 70—Line Trial

In accordance with the parameters of Example 66, the composition of Example 62 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 71—Line Trial

In accordance with the parameters of Example 66, the composition of Example 63 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 72—Line Trial

In accordance with the parameters of Example 66, the composition of Example 64 is tested for a line trial. That is, this composition is extruded into 3.9 mm-thickness sheet by a single screw extruder with a diameter of 120 mm. There is no issue for sheet extrusion. It is then tested in accordance with the procedures for the line trial outlined in Example 66. No significant cracking is observed.

### Example 73—Line Trial

The formulation below in Table AC, is chosen for a line trial. It is similar to the SHL-1 formulation tested in Example 26, however, the SAN portion of SHL-1 is replaced with bulk ABS. The total amount of rubber between the composition below and SHL-1 is the same.

TABLE AC

| High Rubber ABS | SHL-3 Wt, phr |
|---|---|
| HRG (HR-181 from Kumho, | 50 |
| Korea) | |
| ABS (bulk) | 50 |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AD, below, provides the parameters for extrusion.

TABLE AD

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle started from room temperature with all liners being exposed to the ambient conditions (i.e. the refrigerator/freezer door was open or removed). The chamber was cooled to −40° C., holding for 4 h, then heated to 70° C. All refrigerators were then held for 4 h at 70° C. The temperature was then allowed to return to room temperature. 2 h was needed for heating or cooling between −40° C. and 70° C. 1 cycle required 12 h total.

Trial results—The line trial results showed the bulk ABS containing SHL-3 passes the first cycle. No significant cracks are detected.

### Example 74—Line Trial

The formulation below in Table AE, is chosen for a line trial. It is similar to the SHL-1 formulation tested in Example 26, however, the SAN portion of SHL-1 is replaced with ASA. The total amount of rubber between the composition below and SHL-1 is the same.

TABLE AE

| High Rubber ABS | SHL-4 Wt, phr |
|---|---|
| HRG (HR-181 from Kumho, | 50 |
| Korea) | |
| ASA | 50 |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AF, below, provides the parameters for extrusion.

TABLE AF

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle starts from room temperature with all liners being exposed to the ambient conditions (i.e. the refrigerator/freezer door is open or removed). The chamber is cooled to −40° C., holding for 4 h, then heated to 70° C. All refrigerators are then held for 4 h at 70° C. The temperature is then allowed to return to room temperature. 2 h is needed for heating or cooling between −40° C. and 70° C. 1 cycle requires 12 h total.

Trial results—The line trial results showed the ASA containing SHL-4 passes the first cycle. No significant cracks are detected.

### Example 75—Line Trial

The formulation below in Table AG, is chosen for a line trial. It is similar to the SHL-1 formulation tested in Example 26, however, the thermoplastic plastomer/elastomer AX8900 (defined above) is added such that it is 0.5 wt. % of the composition.

TABLE AG

| High Rubber ABS | SHL-5 Wt, phr |
|---|---|
| HRG (HR-181 from Kumho, | 50 |
| Korea) | |
| SAN (PN 137H from ChiMei) | 50 |
| AX8900 | 1.032 (0.5 |
| | wt. %) |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AH, below, provides the parameters for extrusion.

TABLE AH

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle starts from room temperature with all liners being exposed to the ambient conditions (i.e. the refrigerator/freezer door is open or removed). The chamber is cooled to −40° C., holding for 4 h, then heated to 70° C. All refrigerators are then held for 4 h at 70° C. The temperature is then allowed to return to room temperature. 2 h is needed for heating or cooling between −40° C. and 70° C. 1 cycle requires 12 h total.

Trial results—The line trial results showed the ABS containing SHL-5 passes the first cycle. No significant cracks are detected.

### Example 76—Line Trial

Based on the above results, the ESCR test showed the ABS was not cracked when the rubber content was higher than 30 wt %. The formulation below in Table AI, is chosen for a line trial.

TABLE AI

| High Rubber ABS | SHL Wt, phr |
|---|---|
| HRG (HR-181 from Kumho, | 50 |
| Korea) | |
| SAN (PN 137H from ChiMei) | 50 |
| TiO2 | 4.0 |
| EBS | 1 |
| AO1076 | 0.1 |
| AO168 | 0.2 |

The ABS SHL with above formulation is extruded into 3.9 mm-thickness sheet by a single screw extruder with a diameter of 120 mm. There is no issue for sheet extrusion. Table AJ, below, provides the parameters for extrusion.

TABLE AJ

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle starts from room temperature with all liners being exposed to the ambient conditions (i.e. the refrigerator/freezer door is open or removed). The chamber is cooled to −40° C., holding for 4 h, then heated to 70° C. All refrigerators are then held for 4 h at 70° C. The temperature is then allowed to return to room temperature. 2 h is needed for heating or cooling between −40° C. and 70° C. 1 cycle requires 12 h total. This process is repeated for 10 cycles.

Trial results—The line trial results showed the ABS containing SHL-5 passes the first cycle. No significant cracks are detected.

### Example 77—Line Trial

In accordance with Example 26, the composition provided is modified to include a thermoplastic plastomer/elastomer resin. The formulation in Example 26 is provided below in Table AK and is labeled SHL-1, the modified (or second) formulation is the SHL-2.

TABLE AK

| ABS Formulation | SHL -1 Wt, phr | SHL-2 Wt, phr |
|---|---|---|
| HRG | 51.7 | 40 |
| SAN | 48.3 | 60 |
| AX8900 | | 5 |
| TiO2 | 3.0 | 3.0 |
| EBS | 1.2 | 1.0 |
| AO1076 | 0.15 | 0.15 |
| AO168 | 0.3 | 0.3 |

SHL-1 and SHL-2 are extruded into 3.9 mm-thickness sheet by a single screw extruder with a diameter of 120 mm. There is no issue for sheet extrusion. Table AL, below, provides the parameters for extrusion.

TABLE AL

| | | ES173 | | SHL-1 | | SHL-2 | |
|---|---|---|---|---|---|---|---|
| | | | Ac- | | Ac- | | Ac- |
| | | | tual | | tual | | tual |
| | | Set | feed- | Set | feed- | Set | feed- |
| | | point | back | point | back | point | back |
| Main | Z1 | 190 | 239 | 190 | 242 | 185 | 236 |
| Extruder(d = | Z2 | 195 | 245 | 195 | 250 | 190 | 227 |
| 120) | Z3 | 200 | 213 | 200 | 216 | 195 | 204 |
| | Z4 | 180 | 217 | 180 | 219 | 175 | 206 |
| | Z5 | 200 | 201 | 200 | 199 | 210 | 210 |
| | Z6 | 210 | 211 | 210 | 210 | 215 | 216 |
| | Z7 | 220 | 235 | 220 | 238 | 220 | 232 |
| screen changer | 1# | 220 | 220 | 220 | 220 | 230 | 230 |
| area | 2# | 220 | 220 | 220 | 220 | 230 | 225 |
| Connection 1 | | 220 | 168 | 220 | 128 | | |
| metering pump | | 220 | 221 | 220 | 225 | 230 | 230 |
| Connection 2 | | 215 | 196 | 215 | 203 | | |
| Distributor | 1# | 220 | 220 | 220 | 220 | 220 | 220 |
| | 2# | 220 | 228 | 220 | 228 | 220 | 229 |
| die | 1# | 200 | 199 | 220 | 219 | 215 | 214 |
| | 2# | 203 | 203 | 213 | 213 | 222 | 221 |
| | 3# | 228 | 228 | 230 | 233 | 238 | 238 |
| | 4# | 221 | 234 | 221 | 240 | 242 | 242 |
| | 5# | 220 | 222 | 220 | 226 | 225 | 227 |
| | 6# | 216 | 216 | 216 | 217 | 223 | 223 |
| | 7# | 222 | 232 | 222 | 238 | 241 | 242 |
| | 8# | 220 | 218 | 225 | 226 | 230 | 231 |
| | 9# | 200 | 200 | 218 | 216 | 220 | 220 |
| Roll | Top | 75 | 75 | 75 | 75 | 100 | 96 |
| | Middle | 71 | 71 | 71 | 71 | 78 | 78 |
| | Bottom | 65 | 64 | 65 | 64 | 68 | 67 |

| | | | | |
|---|---|---|---|---|
| Main extruder | Rotation | 83.4 | 81.2 | 79 |
| | speed | | | |
| | (Rpm) | | | |
| | Current(A) | 262.4 | 262.8 | 270 |
| Metering | Rotation | 51.0 | 49.8 | 50.0 |
| Pump | speed | | | |
| | (Rpm) | | | |
| | Current(A) | 17.8 | 17.4 | |
| Melt | 120 | 34 | 36 | |
| temperature | 60 | 145 | 214 | |
| Pressure at | 120 | 13.2 | 13.4 | |
| filter | 60 | 0.0 | 0.0 | |

Thermoforming Parameter—The thermal cycle starts from room temperature with all liners being exposed to the ambient conditions (i.e. the refrigerator/freezer door was open or removed). The chamber is cooled to −40° C. or −30° C., holding for 4 h, then heated to 70° C. or 60° C., respectively. All refrigerators are then held for 4 h at 70° C. or 60° C. The temperature is then allowed to slowly return to room temperature. 2 h is needed for heating or cooling between −40° C. and 70° C. or between −30° C. and 60° C. 1 cycle required 12 h total. This process is repeated for 10 cycles.

Trial results—The line trial results showed the ABS containing SHL-2 passes the first cycle. No significant cracks are detected.

### Example 78—Line Trial

The formulation below in Table AM, is chosen for a line trial. It is similar to the SHL-1 formulation tested in Example 26, however, the SAN portion of SHL-1 is replaced with bulk ABS. The total amount of rubber between the composition below and SHL-1 is the same.

TABLE AM

| High Rubber ABS | SHL-3 Wt, phr |
|---|---|
| HRG (HR-181 from Kumho, | 50 |
| Korea) | |
| ABS (bulk) | 50 |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AN, below, provides the parameters for extrusion.

TABLE AN

| | | | | Actual | | | | Actual |
|---|---|---|---|---|---|---|---|---|
| | | | | feed- | | Set | | feed- |
| | | Set point | | back | | point | | back |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle started from room temperature with all liners being exposed to the ambient conditions (i.e. the refrigerator/freezer door was open or removed). The chamber was cooled to −40° C., holding for 4 h, then heated to 70° C. All refrigerators were then held for 4 h at 70° C. The temperature was then allowed to return to room temperature. 2 h was needed for heating or cooling between −40° C. and 70° C. 1 cycle required 12 h total. This process was repeated for 10 cycles.

Trial results—The line trial results showed the bulk ABS containing SHL-3 passes the first cycle. No significant cracks are detected.

### Example 79—Line Trial

The formulation below in Table AO, is chosen for a line trial. It is similar to the SHL-1 formulation tested in Example 26, however, the SAN portion of SHL-1 is replaced with ASA. The total amount of rubber between the composition below and SHL-1 is the same.

TABLE AO

| High Rubber ABS | SHL-4 Wt, phr |
|---|---|
| HRG (HR-181 from Kumho, | 50 |
| Korea) | |
| ASA | 50 |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AP, below, provides the parameters for extrusion.

TABLE AP

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle starts from room temperature with all liners being exposed to the ambient conditions (i.e. the refrigerator/freezer door is open or removed). The chamber is cooled to −40° C., holding for 4 h, then heated to 70° C. All refrigerators are then held for 4 h at 70° C. The temperature is then allowed to return to room temperature. 2 h is needed for heating or cooling between −40° C. and 70° C. 1 cycle requires 12 h total. This process is repeated for 10 cycles.

Trial results—The line trial results showed the ASA containing SHL-4 passes the first cycle. No significant cracks are detected.

### Example 80—Line Trial

The formulation below in Table AQ, is chosen for a line trial. It is similar to the SHL-1 formulation tested in Example 26, however, the thermoplastic plastomer/elastomer AX8900 (defined above) is added such that it is 0.5 wt. % of the composition.

TABLE AQ

| High Rubber ABS | SHL-5 Wt, phr |
|---|---|
| HRG (HR-181 from Kumho, | 50 |
| Korea) | |
| SAN (PN 137H from ChiMei) | 50 |
| AX8900 | 1.032 (0.5 |
| | wt. %) |
| TiO2 | 4.0 |
| EBS | 1 |
| AO1076 | 0.1 |
| AO168 | 0.2 |

The above formulation is extruded into 3.9 mm-thickness sheet by a single screw extruder with a diameter of 120 mm. There is no issue for sheet extrusion. Table AR, below, provides the parameters for extrusion.

TABLE AR

| | | | | Actual | | Set | | Actual |
|---|---|---|---|---|---|---|---|---|
| | | Set point | | feedback | | point | | feedback |
| Tem- | Extruder | Z1 | 190 | 242 | die | 1# | 220 | 220 |
| per- | (d:120 | Z2 | 195 | 250-251 | | 2# | 213 | 213-214 |
| ature | mm) | Z3 | 200 | 217-218 | | 3# | 230 | 233-234 |
| for | | Z4 | 180 | 218-219 | | 4# | 221 | 240-241 |
| each | | Z5 | 200 | 191-199 | | 5# | 220 | 226 |
| part | | Z6 | 210 | 210 | | 6# | 216 | 216-217 |
| (° C.) | | Z7 | 220 | 238-239 | | 7# | 222 | 238-239 |
| | pump | | 220 | 225 | | 8# | 225 | 227-229 |
| | area | | | | | | | |
| | Distrib- | 1# | 220 | 220 | | 9# | 218 | 218 |
| | utor | | | | | | | |
| | | 2# | 220 | 228 | top | | 75 | 75 |
| | | | | | roll | | | |
| | screen | 1# | 220 | 220 | middle | | 71 | 71 |
| | changer | | | | roll | | | |
| | area | 2# | 220 | 220 | bottom | | 65 | 64 |
| | | | | | roll | | | |

| | | | |
|---|---|---|---|
| Other | Main | Rotation | 79-88 |
| pa- | extruder | rate(Rpm) | |
| ram- | | Electricity | 243-269 |
| eters | | current(A) | |
| | Pump | Rotation | 49.8 |
| | | rate(Rpm) | |
| | | Electricity | 17.4 |
| | | current(A) | |

Thermoforming Parameter—Generally, the thermal cycle starts from room temperature with all liners being exposed to the ambient conditions (i.e. the refrigerator/freezer door is open or removed). The chamber is cooled to −40° C., holding for 4 h, then heated to 70° C. All refrigerators are then held for 4 h at 70° C. The temperature is then allowed to return to room temperature. 2 h is needed for heating or cooling between −40° C. and 70° C. 1 cycle requires 12 h total. This process is repeated for 10 cycles.

Trial results—The line trial results showed the ABS containing SHL-5 passes the first cycle. No significant cracks are detected.

What is claimed is:

1. A liner for use in a refrigeration appliance comprising:
(a) at least one co-polymeric chain which imparts plastic characteristics to said liner material; and
(b) one or more rubber moieties grafted to and/or dispersed in said at least one first co-polymeric chain, wherein said one or more rubber moieties comprises at least about 30% by weight of said liner.

2. A liner for use in a refrigeration appliance comprising:
(a) at least one co-polymeric chain which imparts plastic characteristics to said liner material; and
(b) one or more rubber moieties grafted to and/or dispersed in said at least one co-polymeric chain, wherein said one or more rubber moieties are present in the liner in an amount effective to ensure that said liner exhibits no stress cracking after one thermal test cycle.

3. The liner of claim 1 wherein said at least one co-polymeric chain comprises polymeric chains formed by copolymerization of monoalkenyl aromatic monomers and ethylenically unsaturated nitrile monomers.

4. The liner of claim 3 wherein said monoalkenyl aromatic monomers comprise styrene and said ethylenically unsaturated nitrile monomers comprise acrylonoitrile.

5. The liner of claim 1 wherein said at least one co-polymeric chain comprises first co-polymeric chains having substantially no rubber moieties grafted thereto and second co-polymeric chains having rubber moieties grafted thereto.

6. The liner of claim 5 wherein said first and said second co-polymeric chains each comprises polymeric chains formed by copolymerization of monoalkenyl aromatic monomers and ethylenically unsaturated nitrile monomers.

7. The liner of claim 6 wherein said second co-polymeric chains comprise at least about 50% by weight of rubber moieties grafted thereto.

8. The liner of claim 1 wherein said at least one co-polymeric chain comprises: (i) first co-polymeric chains having rubber moieties grafted thereto, wherein the amount of said rubber moieties grafted to said first co-polymeric chains is not greater than about 24% by weight based on the weight of said first co-polymeric chains and said rubber moieties grafted to said first co-polymeric chains; and (ii) second co-polymeric chains having rubber moieties grafted thereto, wherein the amount of said rubber moieties grafted to said second co-polymeric chains is not less than about 40% by weight based on the weight of said second co-polymeric chains and said rubber moieties grafted to said second co-polymeric chains.

9. The liner of claim 1 wherein said liner further comprises at least one thermoplastic plastomer/elastomer.

10. The liner of claim 9 wherein said at least one thermoplastic plastomer/elastomer is substantially uniformly distributed throughout said liner.

11. The liner of claim 9 wherein said at least one thermoplastic plastomer/elastomer is substantially uniformly dispersed throughout said liner.

12. The liner of claim 1 wherein said rubber moieties are selected from and/or produced from monomers selected from the group consisting of butadiene, styrene-butadiene, butadiene-acrylonitrile copolymers, isoprene, ethylene/propylene rubbers, ethylene/propylene/diene rubbers, nonconjugated diene, crosslinked alkylacrylate rubber, and combinations any two or more thereof.

13. A polymeric material comprising:
(a) at least first co-polymeric chains which impart plastic characteristics to said polymeric material, wherein said first co-polymeric chains have rubber moieties grafted thereto and/or rubber moieties in fine particulate form distributed substantially uniformly therethrough; and
(b) second co-polymeric chains having rubber moieties grafted thereto, wherein the amount of said rubber moieties grafted to said second co-polymeric chains is not less than about 40% by weight based on the weight of said second co-polymeric chains and said rubber moieties grafted to said second co-polymeric chains,
wherein the total rubber moieties in said polymeric material comprises from about 30% by weight to about 50% by weight of said polymeric material.

14. The polymeric material of claim 13 wherein said first and second co-polymeric chains are each formed by steps comprising copolymerization of monoalkenyl aromatic monomers and ethylenically unsaturated nitrile monomers.

15. A polymeric material comprising:
(a) at least first co-polymeric chains which impart plastic characteristics to said liner material, wherein said first co-polymeric chains have (i) no rubber moieties grafted thereto; or (ii) rubber moieties grafted thereto; and/or rubber moieties in fine particulate form distributed substantially uniformly therethrough, wherein the amount of said rubber moieties grafted to and distributed in said first co-polymeric chains together is not greater than about 24% by weight based on the weight of said first co-polymeric chains and said rubber moieties grafted to and distributed in said first co-polymeric chains; or a combination of (i) and (ii); and
(b) thermoplastic plastomer/elastomer in an amount of at least about 0.5% by weight based on the total weight of said polymeric material.

16. The polymeric material of claim 15 wherein said thermoplastic plastomer/elastomer comprises a co-polymer or terpolymer of at least one non-polar monomer and at least one polar monomers.

17. The polymeric material of claim 16 wherein said non-polar monomer is selected from the group consisting of ethylene, propylene, butylene, butadiene, pentadiene, hexylene, octylene, styrene, and combinations thereof.

18. The polymeric material of claim 16 wherein said polar monomer is selected from the group consisting of vinyl acetate, alkyl acrylate, glycidyl methylacrylate, maleic anhydride, and combinations thereof.

19. The polymeric material of claim 16 wherein said thermoplastic plastomer/elastomer comprises a terpolymer of ethylene, alkyl acrylate, and glycidyl methacrylate.
